(19) United States
(12) Patent Application Publication
(10) Pub. No.: US 2014/0354219 A1
(43) Pub. Date: Dec. 4, 2014

(54) WIRELESS CHARGING APPARATUS

(71) Applicant: Eagle Fan, Hsinchu (TW)

(72) Inventor: Eagle Fan, Hsinchu (TW)

(21) Appl. No.: 13/904,636

(22) Filed: May 29, 2013

(51) Int. Cl. H02J 7/02; H02J 7/00

(52) U.S. Cl. CPC H02J 7/025; H02J 7/0042
USPC 320/108

(57) ABSTRACT

A wireless charging apparatus includes a first body, a second body and a plug unit. The first body has a placement area on surface and a charging module inside. The charging module is located correspondingly to placement area and includes at least a transmitting induction coil and a control circuit unit. The second body is coupled to first body on one side. When flipped open, the two bodies form an angle, and the placement area is horizontal so as to place electronic device on placement area. The plug unit is on second body, located at back of second body facing away from first body. The plug unit includes at least two metal insertion elements, electrically connected to charging module internally. As such, when in use, the plug unit is plugged into wall socket, and the electronic device is placed on placement area of first body for wireless charging.

### FIELD OF THE INVENTION

The present invention generally relates to a wireless charging apparatus, and more specifically to an apparatus for plugging into wall socket and able to perform wireless charging on an electronic device placed on the apparatus, convenient for mobility and storage.

### BACKGROUND OF THE INVENTION

As the wireless charging technology matures, the charging efficiency improves. Currently, some mobile devices, such as, mobile phone, personal video player and digital camera, gradually adopt the wireless charging. These mobile devices use the built-in receiving induction coil to electrically connect to the battery. The wireless charging apparatus includes built-in transmitting induction coil. When the two are in proximity, the battery of the mobile device can be charged by power conversion through the energy propagation based on electromagnetic effect and electromagnetic resonance.

A common wireless charging device includes a power cord and a wireless charging pad. The wireless charging pad allows an electronic device to be placed upon for wireless charging, and the power cord includes a plug at the end to plug into a socket so that the wireless charging can be conducted through electromagnetic induction. Although it is convenient to use, the wireless charging apparatus is often inconvenient for portability and storage. For example, the long power cord is often wrapped around the wireless charging pad to become too bulky to port. A loose power cord can tangle with other items when placed in backpack. During charging, the long power cord is prone to trip people over or be pulled off accidentally to damage the charged device. Therefore, it is desirable to devise a wireless charging apparatus convenient for mobility and storage for users.

### SUMMARY OF THE INVENTION

The present invention has been made to overcome the above-mentioned drawback of conventional wireless charging apparatus. The primary object of the present invention is to provide a wireless charging apparatus, able to plug in a wall socket and provide a place for placing an electronic device for wireless charging to reduce the possibility of accidental bumping. The present invention has a foldable structure, and has no exposed power cord. When folded, the present invention has a small size convenient for mobility and storage.

Another object of the present invention is to provide a wireless charging apparatus, able to serve as a support stand. When an electronic device, such as mobile phone, is placed on the present invention, the electronic device can stand on a flat surface in a tilt position, convenient for viewing.

To achieve the above objects, the present invention includes a first body, a second body and a plug unit. The first body is disposed with a placement area on a surface, and includes a charging module inside the first body. The charging module is located at a location corresponding to the placement area and includes at least a transmitting induction coil and a control circuit unit. The second body has a side coupled to the first body. When flipped open, the first body and the second body form an angle, and the placement area of the first body is along the horizontal direction so that an electronic device can be placed on the placement area. The plug unit is disposed on the second body, located at back of the second body facing away from the first body. The plug unit includes at least two metal insertion elements. The metal insertion elements are electrically connected to the charging module inside the first body through internal path. As such, when in use, the first body and the second body are expanded to form an L-shape, the plug unit on the second body is plugged into the wall socket, and the electronic device is placed on the placement area of the first body for wireless charging.

In addition, the coupling of the first body and the second body demonstrates a certain rigidity so that when an external force applied to adjust the angle between the two bodies vanishes, the two bodies maintain the adjusted angle. Furthermore, the second body further includes at least a stop element, partially coupled to the second body and located on the same side as the plug unit. The stop element, after flipped, protrudes above the surface of the second body so that the present invention can be used as a support stand.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the present invention in a folded state;

FIG. 2 shows a schematic view of the present invention in a expanded state;

FIG. 3 shows a schematic view of the plug unit of the present invention being rotated by an angle;

FIG. 4 shows a cross-sectional view along the AA side of FIG. 2;

FIG. 5 shows a schematic view of the present invention in another expanded state;

FIG. 6 shows a schematic view of an electronic device placed on the present invention for wireless charging;

FIG. 7 shows a schematic view of the present invention being plugged into a wall socket; and

FIG. 8 shows a schematic view of the present invention used as a support stand for an electronic device.

### DETAILED DESCRIPTION OF THE PREFERRED EMBODIMENTS

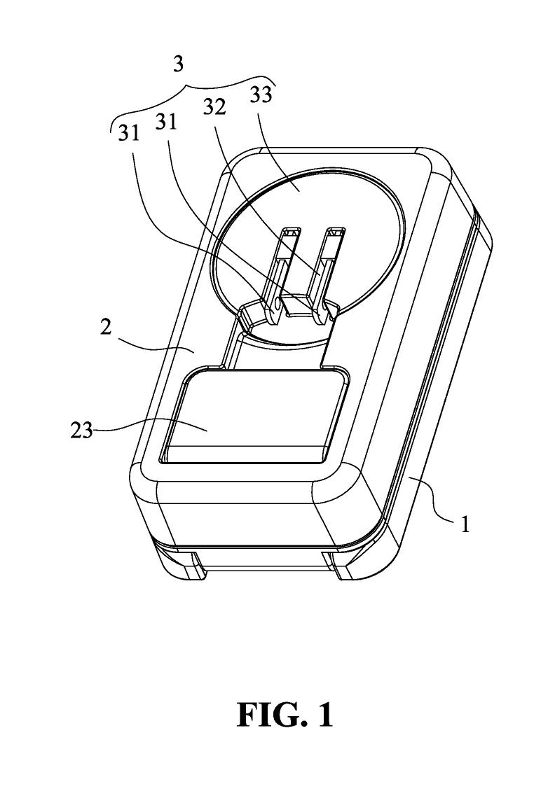

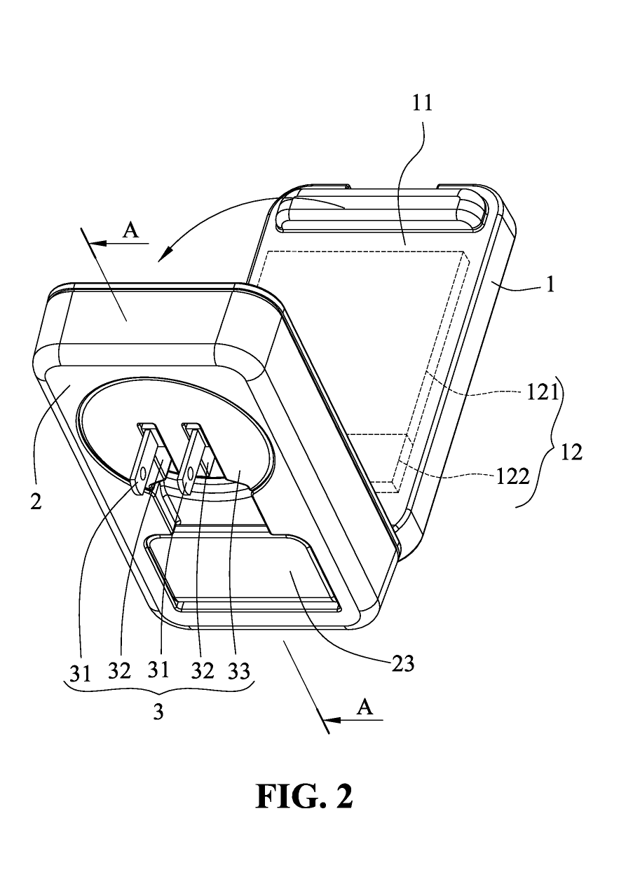

FIG. 1 and FIG. 2 show schematic views of the present invention in a folded state and an expanded state, respectively. A wireless charging apparatus of the present invention includes a first body 1, a second body 2 and at least a plug unit 3.

The first body 1 and the second body 2 both have a long rectangular shape, with hollow inside for accommodating other components of the present invention. The first body 1 and the second body 2 are coupled together, can be folded (as in FIG. 1) for convenient storage when not in use, and can be expanded to form an L-shape (as in FIG. 2). In the present embodiment, the first body 1 and the second body 2 can be expanded to form an angle up to 100°. For the convenience of wireless charging, the preferred angle between the first body 1 and the second body 2 is between 85° and 95°. A surface of the first body 1 includes a placement area 11 for placing an electronic device. The placement area 11 is located facing the second body 2. The inside of the first body 1 includes a charging module 12, located correspondingly to the placement area 11. The charging module 12 includes at least a transmitting induction coil 121 and a control circuit unit 122. The control circuit unit 122 is electrically connected to the transmitting induction coil 121 to enable the transmitting induction coil 121 to cause electromagnetic effect in the corresponding electronic device for wireless charging. The charging module 12 can include one or more circuit boards. When a single circuit board is included, the circuit board will be disposed with both the transmitting induction coil 121 and the control circuit unit 122.

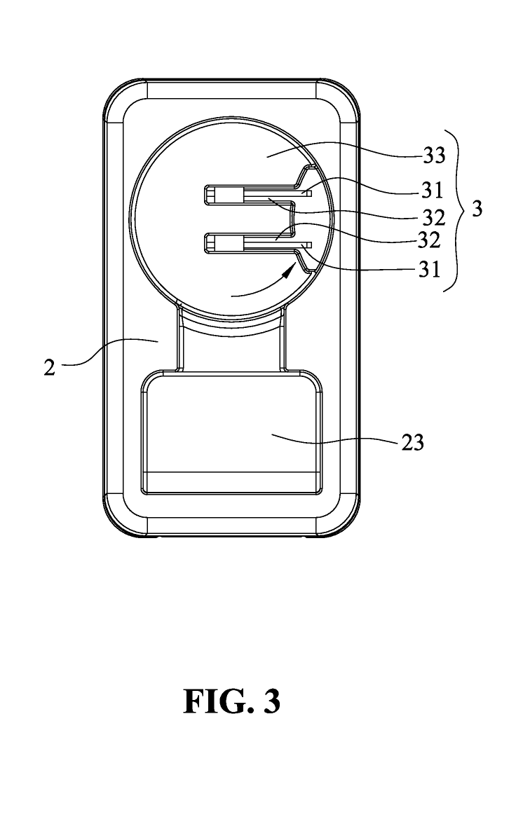

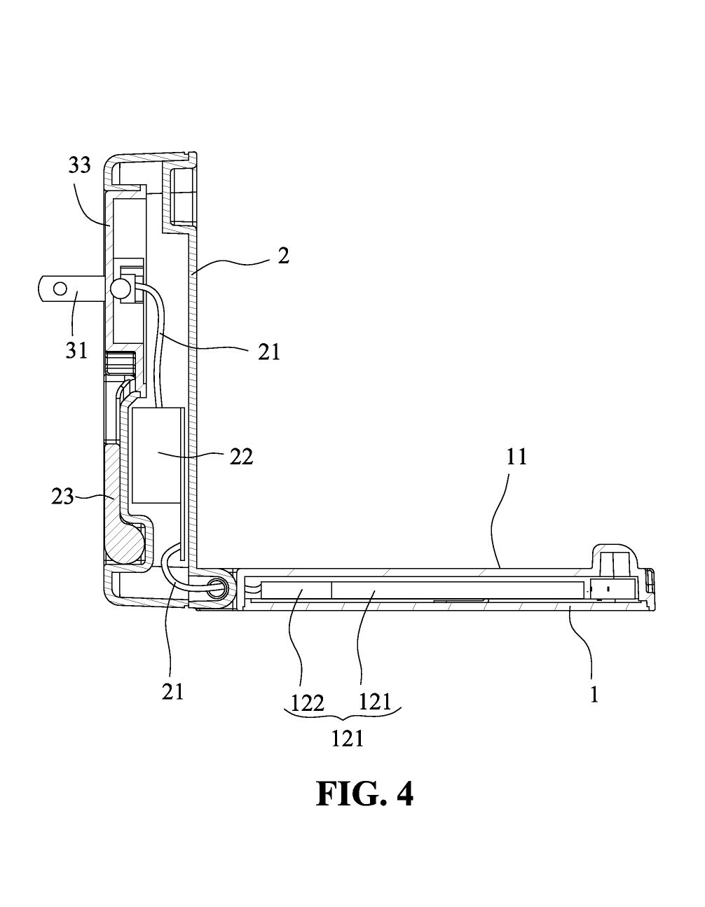

The plug unit 3 is disposed on the second body 2, located on the side of the second body 2 facing away from the first body 1. The plug unit 3 includes at least two exposed metal insertion elements 31. The metal insertion elements 31 are electrically connected through the second body 2 internally to the charging module 12 inside the first body 1. For storage convenience, the plug unit 3 further includes a plurality of trenches 32, with each trench 32 corresponds to a metal insertion element 31. The metal insertion element 31 is partially coupled to the inner wall of the trench 32, and can be housed inside the trench 32 when flipped. Furthermore, as some wall sockets are vertically oriented and some are horizontally oriented, the plug unit 3 of the present invention further includes a rotatable element 33, disposed on the second body 2 for 0-90° rotation. In principle, it is only required to switch between 0° and 90° to fit the horizontally or vertically oriented wall sockets. FIG. 3 shows a state when rotated to 90°. In the present embodiment, the trenches 32 are located at rotatable element 33 and the metal insertion elements 31 are also disposed at this location. The ends of the metal insertion elements 31 will extend into the internal of the second body 2 (as shown in FIG. 4) and are electrically connected by wire 21 to the charging module 12. Considering the voltage transformation, the second body 2 can further include a transformer rectifier circuit 22, electrically connected to the wire 21 to provide appropriate voltage to the charging module 12.

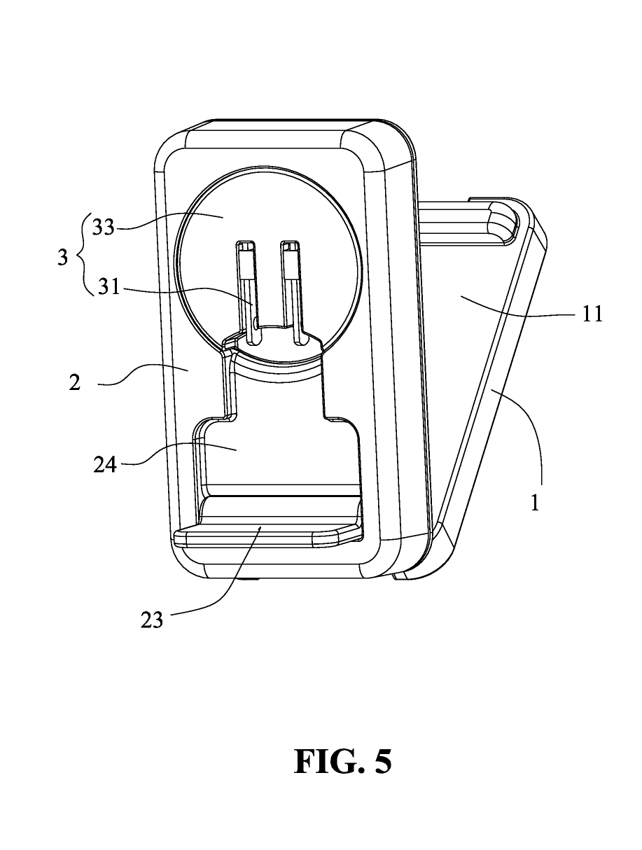

The wireless charging apparatus of the present invention can also be used as a support stand when not in use as a recharger. The coupling of the first body 1 and the second body 2 demonstrates a certain rigidity and yet rotatable. When an external force applied to adjust the angle between the two bodies vanishes, the two bodies maintain the adjusted angle. As this type of coupling is commonly known, the detailed description is omitted here. Furthermore, the second body 2 further includes at least a stop element 23, partially coupled to the second body 2 and located on the same side as the plug unit 3. The stop element 23, after flipped, protrudes above the surface of the second body 2 (as shown in FIG. 5). For esthetics, the second body 2 further includes a concave housing space 24, and the stop element 23 is coupled to the inner wall of the housing space 24. When not in use, the stop element 23 is flipped to be housed inside the housing space 24, as shown in FIG. 1.

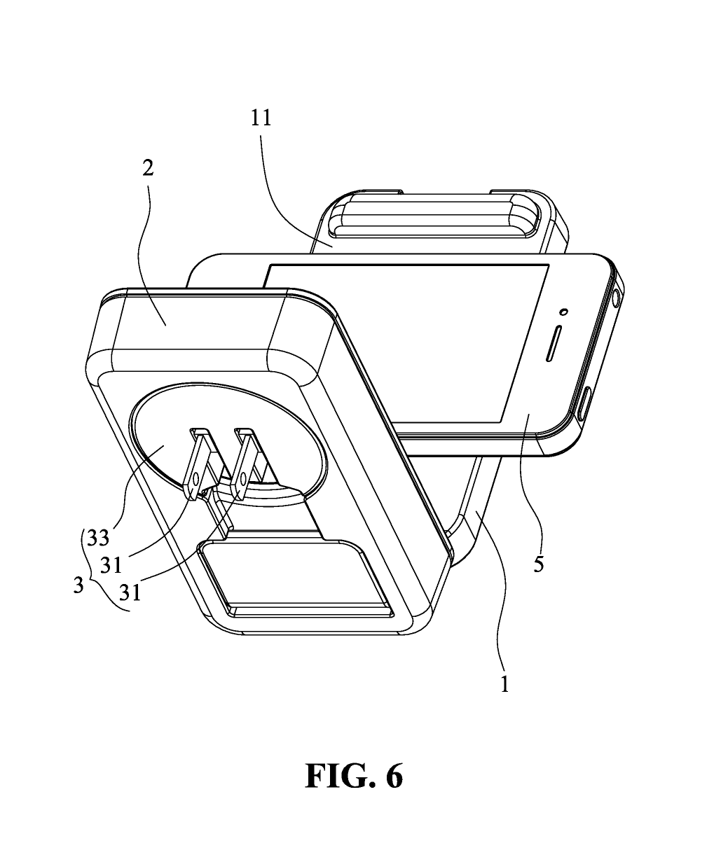

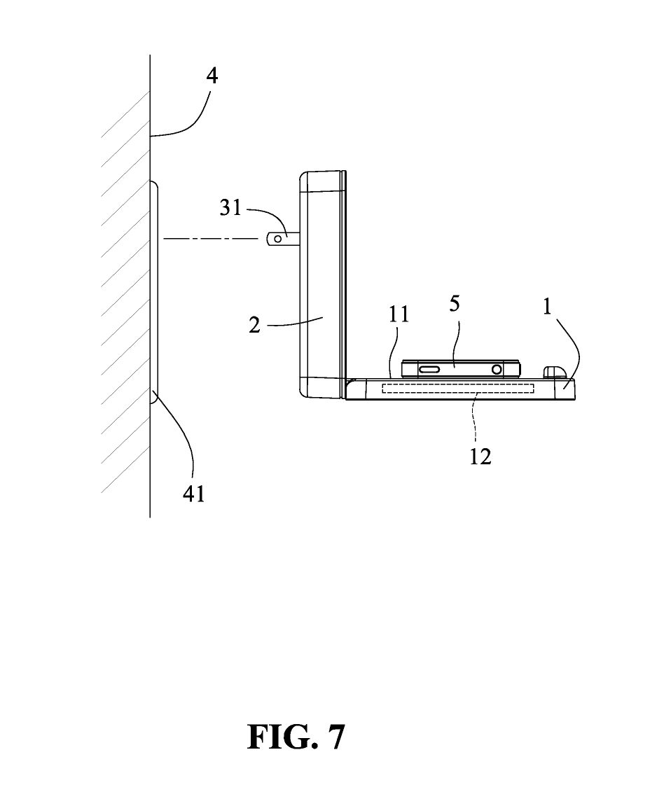

The following shows schematic views of the present invention in actual application. FIG. 6 and FIG. 7 show a schematic view and a side view of the present invention providing wireless charging to electronic device, respectively. To use the present invention, the metal insertion elements 31 of the plug unit 3 are flipped open to protrude above the side of the second body 2. Also, the first body 1 and the second body 2 are adjusted to form a right angle. At this point, the metal insertion elements 31 are plugged into a socket 41 on a wall 4, and the placement area 11 of the first body 1 is flat horizontally. The charging module 12 inside the first body 1 is connected to the power supplied from the socket 41 and ready for charging. A wirelessly chargeable electronic device 5 is placed on the placement area 11. In the instant embodiment, the electronic device is a mobile phone. In the process of wireless charging, the transmitting induction coil of the charging module 12 and the receiving induction coil of the electronic device 5 can charge the battery of the electronic device 5 by power conversion through the energy propagation based on electromagnetic effect and electromagnetic resonance. Because the wireless charging apparatus of the present invention is directly plugged into the socket 41 on the wall 4 when in use for charging, no power cord is exposed, and thus eliminates the accidental tripping over to cause fall and damage of the wireless charging apparatus and the electronic device 5 to be charged. In addition, for storage, the first body 1 and the second body 2 can be folded to reduce size.

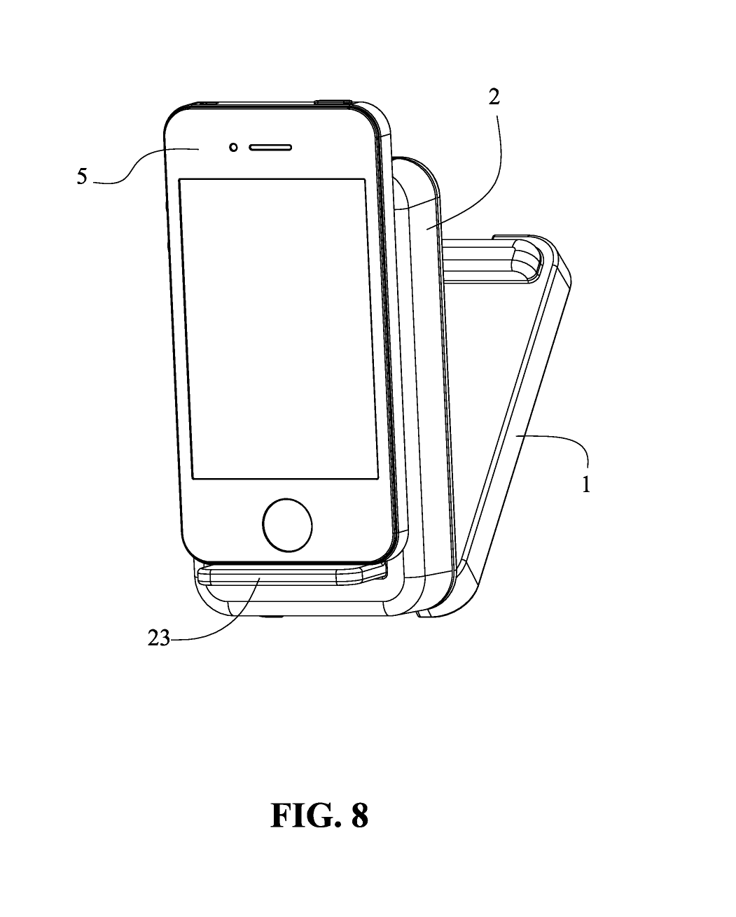

FIG. 8 shows a schematic view of the present invention used as a support stand for the electronic device 5 to stand on a desk. As shown in FIG. 8, the second body 2 is flipped open so that the first body 1 and the second body 2 form an acute angle. As aforementioned, the adjusted angle can stay fixed after the applied external force vanishes. The stop element 23 is then flipped open so that the stop element 23 protrudes above the surface of the second body 2 to form a support stand for placing the electronic device 5. By placing the electronic device 5 on the second body 2 with the lower edge of the electronic device 5 contacting the stop element 23, the electronic device 5 will not slip from the wireless charging apparatus. To adjust the standing angle of the electronic device 5, the angle between the first body 1 and the second body 2 can be adjusted.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A wireless charging apparatus, comprising: a first body, a second body and a plug unit;
wherein the first body having a placement area on a surface, and having a charging module inside the first body; the charging module being located at a location corresponding to the placement area and having at least a transmitting induction coil and a control circuit unit;
the second body having a side coupled to the first body; when flipped open, the first body and the second body forming an angle, and the placement area of the first body being along the horizontal direction so that an electronic device able to placed on the placement area; and
the plug unit being disposed on the second body, located at back of the second body facing away from the first body; the plug unit having at least two metal insertion elements; the metal insertion elements being electrically connected to the charging module inside the first body through internal path.

2. The wireless charging apparatus as claimed in claim 1, wherein the plug unit further comprises a plurality of trenches, with each trench corresponds to a metal insertion element; the metal insertion element is partially coupled to the inner wall of the trench, and can be housed inside the trench when flipped.

3. The wireless charging apparatus as claimed in claim 2, wherein the plug unit further comprises a rotatable element, the plurality of trenches is located at rotatable element and the metal insertion elements are partially coupled to the plurality of trenches at the rotatable element; the rotatable element is disposed on the second body, located on a same side as the plug unit, and the rotatable element can change the orientation of the metal insertion elements by rotation.

4. The wireless charging apparatus as claimed in claim 3, wherein the rotatable element can rotate between 0°-90°.

5. The wireless charging apparatus as claimed in claim 1, wherein the first body and the second body can press tightly against each other than folded, and can be expanded to form an angle preferably between 85°-95°.

6. The wireless charging apparatus as claimed in claim 1, wherein the coupling of the first body and the second body demonstrates a rigidity so that when an external force applied to adjust the angle between the two bodies vanishes, the two bodies maintain the adjusted angle.

7. The wireless charging apparatus as claimed in claim 1, wherein the second body further comprises at least a stop element, partially coupled to the second body and located on a same side as the plug unit; and the stop element, after flipped, protrudes above the surface of the second body.
